(19) United States
(12) Patent Application Publication
(10) Pub. No.: US 2025/0139458 A1
(43) Pub. Date: May 1, 2025

(54) METHOD AND DEVICE FOR AUTOMATICALLY BUILDING ARTIFICIAL INTELLIGENCE MODEL BY USING DATASET SELECTED BY USER

(71) Applicant: Kaier Co., Ltd., Seoul (KR)

(72) Inventor: Kyohyuk LEE, Seongnam-si (KR)

(73) Assignee: Kaier Co., Ltd., Seoul (KR)

(21) Appl. No.: 18/922,816

(22) Filed: Oct. 22, 2024

(30) Foreign Application Priority Data
Oct. 27, 2023 (KR) 10-2023-0145649

(51) Int. Cl. G06N 3/0985

(52) U.S. Cl. CPC G06N 3/0985

(57) ABSTRACT

Provided is a method and device for automatically building an artificial intelligence model using a dataset selected by a user, and a process of adjusting multiple hyperparameters, a process of adjusting multiple modeling elements, and a process of training the artificial intelligence model using one dataset selected by a user are repeated until performance of the artificial intelligence model is converged, and accordingly, an artificial intelligence model that may provide highly accurate prediction results with an optimal and efficient structure for the dataset selected by the user may be automatically built.

### CROSS-REFERENCE TO RELATED APPLICATION

This application is based on and claims priority under 35 U.S.C. § 119 to Korean Patent Application No. 10-2023-0145649, filed on Oct. 27, 2023, in the Korean Intellectual Property Office, the disclosure of which is incorporated by reference herein in its entirety.

### BACKGROUND

The present disclosure relates to a method and device for automatically building an artificial intelligence model without user intervention.

Recently, the use of artificial intelligence models in various industrial fields has been rapidly increased. In order to build an artificial intelligence model, a large amount of data to be used for training the artificial intelligence model has to be collected, and labeling task for the collected data has to be performed in advance. When a large amount of data to be used for training the artificial intelligence model is prepared, hyperparameter design suitable for a training dataset and structure design of the artificial intelligence model have to be performed. Because this series of tasks were performed manually by people, a lot of time and manpower had to be invested in building the artificial intelligence model.

Research is actively being conducted to automate a series of tasks for building an artificial intelligence model. For example, Korean Patent No. 10-2579116, “Apparatus for Cloud-based Artificial Intelligence Automatic Learning and Distribution and Method Therefor,” suggests a technology that automatically performs artificial intelligence learning and distribution with just a few clicks. Korean Patent No. 10-2579116, “Apparatus and method for automatically learning and distributing artificial intelligence based on the cloud” discloses technology that separates some of data into learning data and automatically performs data labeling on objects in the data through automatic learning of data for learning. However, the conventional technology is limited to data labeling and automating of a learning process, and thus, a great deal of time and manpower still has to be invested in building an artificial intelligence model.

### SUMMARY

The present disclosure provides a method and device for automatically building an artificial intelligence model that may provide a highly accurate prediction result with an optimal and efficient structure for a dataset selected by a user simply by selecting any one of multiple datasets. The present disclosure is not limited to the technical tasks described above, and other technical tasks may be derived from the following descriptions.

According to an aspect of the present disclosure, an artificial intelligence model automatic building method includes receiving a dataset selected by a user among multiple datasets; training an artificial intelligence model according to multiple hyperparameters using the dataset selected by the user; determining whether performance of the artificial intelligence model is converged based on an output of a trained artificial intelligence model; and adjusting the multiple hyperparameters according to whether the performance of the artificial intelligence model is converged, and wherein the artificial intelligence model is trained again according to the adjusted multiple hyperparameters, and the adjustment of the multiple hyperparameters and the training of the artificial intelligence model are repeated until the performance of the artificial intelligence model is converged.

In the determining of whether the performance of the artificial intelligence model is converged, whether the performance of the artificial intelligence model is converged may be determined based on a difference between an output of the trained artificial intelligence model and a label of the dataset.

The multiple parameters may include a batch size which is a division size of a training dataset of the dataset selected by the user, and the training of the artificial intelligence model may include calculating a forward propagation loss of each mini-batch from a difference between an output of the artificial intelligence model for each of multiple mini-matches divided from the training dataset according to the batch size and a label of the dataset selected by the user; and training the artificial intelligence model by backpropagating the calculated forward propagation loss of the each mini-batch through the artificial intelligence model.

The multiple hyperparameters may further include an epoch number which is a number of repetitions of training of the artificial intelligence model, the artificial intelligence model automatic building method may further include calculating a training loss of a current epoch from multiple forward propagation losses calculated for all of multiple mini-batches, when the training of the artificial intelligence model for all of the multiple mini-batches is completed in the current epoch, which is one epoch in which the training of the artificial intelligence model is currently being performed among multiple epochs according to the epoch number, and in the determining of whether the performance of the artificial intelligence model is converged, whether the performance of the artificial intelligence model is converged in a current training cycle which is a training cycle corresponding to the multiple epochs according to the epoch number may be determined based on the calculated training loss of the current epoch and a training loss of the multiple epochs prior to the current epoch.

In the calculating of the training loss of the current epoch, training accuracy of the current epoch may be calculated from a number of outputs that match a label of the one dataset among multiple outputs of the artificial intelligence mode for all of the multiple mini-batches, together with a training loss of the current epoch and, in the determining of whether the performance of the artificial intelligence model is converged, whether the performance of the artificial intelligence model is converged in the current training cycle may be determined based on the calculated training loss and training accuracy of the current epoch and training losses and accuracies of the multiple epochs prior to the current epoch.

The artificial intelligence model automatic building method may further include determining whether the performance of the artificial intelligence model in an entire training process consisting of the current training cycle and multiple training cycles prior to the current training cycle is converged, when the performance of the artificial intelligence model in the current training cycle is converged, wherein, in the adjusting of the multiple hyperparameters, the multiple hyperparameters may be adjusted when the performance of the artificial intelligence model in the current training cycle is converged before the performance of the artificial intelligence model in the entire training process is converged.

In the adjusting of the multiple hyperparameters, the multiple hyperparameters may be adjusted such that training loss calculated from a preset number of the multiple training cycles decreases based on a change pattern of the training loss calculated from the preset number of the multiple training cycles in the entire training process.

The artificial intelligence model automatic building method may further include calculating valid loss of the current epoch from a difference between multiple outputs of an artificial intelligence model obtained by inputting a validation dataset among the one dataset to the trained artificial intelligence model and a label of the one dataset; and selecting an artificial intelligence model trained in one training cycle among artificial intelligence models trained in each of multiple training cycles constituting the entire training process based on multiple valid losses calculated from multiple training cycles constituting the entire training process when the performance of the artificial intelligence model in the entire training process is converged.

In the calculating of valid loss of the current epoch, valid accuracy of the current epoch may be calculated from outputs that match a label of the dataset among multiple outputs of the artificial intelligence model obtained by inputting the valid dataset to the trained artificial intelligence model, together with valid loss of the current epoch, and in the selecting of the artificial intelligence model, an artificial intelligence model trained in one training cycle may be selected from among artificial intelligence models trained in each of multiple training cycles constituting the entire training process, based on multiple valid losses and multiple valid accuracies calculated in the multiple training cycles constituting the entire training process.

The artificial intelligence model automatic building method may further include modeling the artificial intelligence model according to multiple modeling elements, wherein, in the adjusting of the multiple hyperparameters, the multiple hyperparameters and the multiple modeling elements may be adjusted, and the artificial intelligence model may be re-modeled according to the adjusted multiple modeling elements, and adjustment of the multiple hyperparameters and the multiple modeling elements and the training of the artificial intelligence model may be repeated until the performance of the artificial intelligence model is converged.

The multiple modeling elements may include at least one of a neuron number of respective layers of the artificial intelligence model and a layer number of the artificial intelligence model.

According to another aspect of the present disclosure, a computer-readable recording medium in which a program for performing an artificial intelligence model automatic building method by a computer is recorded.

According to another aspect of the present disclosure, an automatic artificial intelligence model building device includes a user interface configured to receive a dataset selected by a user among multiple datasets; a training unit configured to train an artificial intelligence model according to multiple hyperparameters using the dataset selected by the user; and a controller configured to determine whether performance of the artificial intelligence model is converged based on an output of a trained artificial intelligence model, and adjust the multiple hyperparameters according to whether the performance of the artificial intelligence model is converged, wherein the artificial intelligence model is trained again according to the adjusted multiple hyperparameters, and the adjustment of the multiple hyperparameters and the training of the artificial intelligence model are repeated until the performance of the artificial intelligence model is converged.

### BRIEF DESCRIPTION OF THE DRAWINGS

Embodiments will be more clearly understood from the following detailed description taken in conjunction with the accompanying drawings in which:

FIG. 1 is a configuration diagram of an automatic artificial intelligence model construction device according to an embodiment of the present disclosure;

FIG. 2 is a flowchart of an automatic artificial intelligence model construction method according to an embodiment of the present disclosure;

FIG. 3 is an example view of a home screen among output screens of a user interface 10 illustrated in FIG. 1;

FIGS. 4 and 5 are example views of a dataset selection screen among output screens of the user interface 10 illustrated in FIG. 1;

FIG. 6 is an example view of a training start screen among output screens of the user interface 10 illustrated in FIG. 1;

FIGS. 7A, 7B, and 8 are example diagrams of modeling elements of a modeling unit 40 illustrated in FIG. 1;

FIG. 9 is an example view of a training progress screen among output screens of the user interface 10 illustrated in FIG. 1; and

FIG. 10 is an example view of a loss and accuracy display screen among output screens of the user interface 10 illustrated in FIG. 1.

### DETAILED DESCRIPTION OF THE EMBODIMENTS

Hereinafter, an embodiment of the present disclosure will be described in detail with reference to the drawings. Hereinafter, a method and device for automatically building an artificial intelligence model that may provide a highly accurate prediction result with an optimal and efficient structure for a dataset selected by a user simply by selecting any one of multiple datasets. Hereinafter, the method and device are respectively and briefly referred to as an “artificial intelligence model automatic building device” and an “artificial intelligence model automatic building method.”

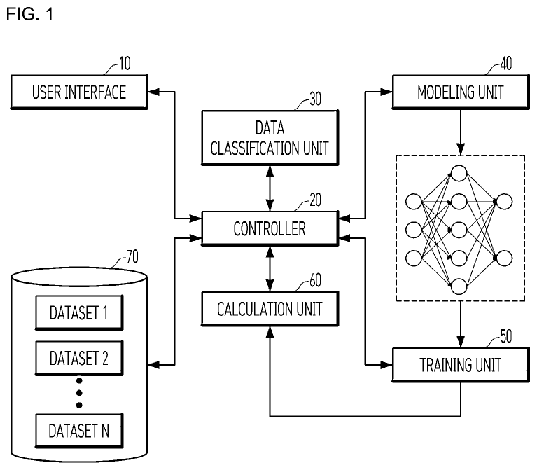

FIG. 1 is a configuration diagram of an artificial intelligence model automatic building device according to an embodiment of the present disclosure. Referring to FIG. 1, an artificial intelligence model automatic building device according to the present embodiment includes a user interface 10, a controller 20, a data classification unit 30, a modeling unit 40, a training unit 50, a calculation unit 60, and a storage 70. In order to make the present embodiment easily understandable while preventing features of the present embodiment from being obscured, essential components of the present embodiment are illustrated in FIG. 1. Those skilled in the art to which the present embodiments belong may understand that other configurations may be added in addition to the configuration illustrated in FIG. 1.

The user interface 10 receives a command or information from a user or outputs a video, an image, a text, and so on. The user interface 10 may be implemented by a display panel, a touch screen, or so on. The controller 20 controls an operation of at least one of the data classification unit 30, the modeling unit 40, the training unit 50, and the calculation unit 60 according to a user's command or information which is input through the user interface 10, or controls operations of other components according to a data processing result of any one of the data classification unit 30, the modeling unit 40, the training unit 50, and the calculation unit 60.

The controller 20, the data classification unit 30, the modeling unit 40, the training unit 50, and the calculation unit 60 may be implemented by a combination of a processor and a computer program, or may be implemented by a field programmable gate array (FPGA). The storage 70 stores the data required for building an artificial intelligence model according to the present embodiment, for example, multiple datasets. The storage 70 may also store a computer program for implementing at least one of the controller 20, the data classification unit 30, the modeling unit 40, the training unit 50, and the calculation unit 60. The storage 70 may be implemented by a combination of random access memory (RAM), read only memory (ROM), a solid state drive (SSD), and so on.

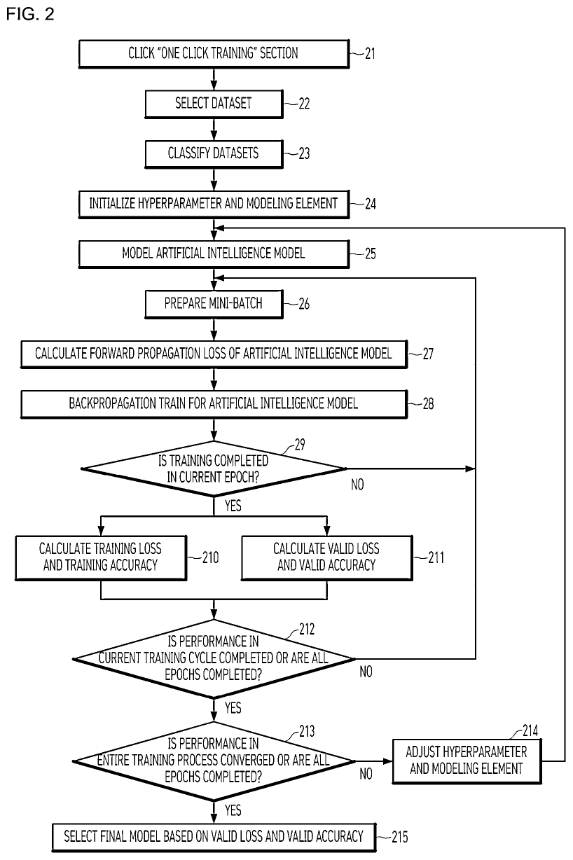

FIG. 2 is a flowchart of an artificial intelligence model automatic building method according to an embodiment of the present disclosure. Referring to FIG. 2, the artificial intelligence model automatic building method according to the present embodiment includes following steps performed by the artificial intelligence model automatic building device illustrated in FIG. 1. Hereinafter, the artificial intelligence model automatic building device illustrated in FIG. 1 is described in detail with reference to FIG. 1 and FIG. 2. In the present embodiment, a process of building an artificial intelligence (AI) model includes a process of modeling the AI model and a process of training the modelled AI model. According to the present embodiment, the process of building an AI model is automatically performed without user intervention.

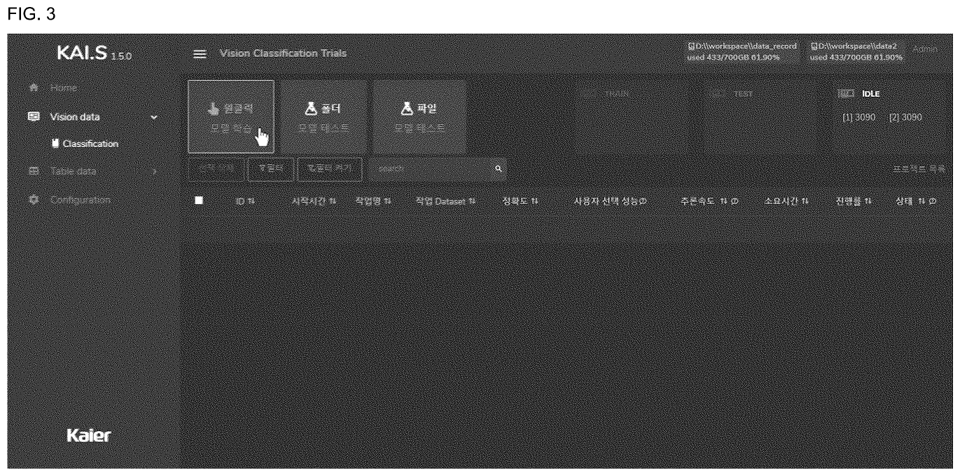

In step 21, the controller 20 generates home screen content for user interaction required for building an AI model, and outputs a home screen according to the home screen content generated in this way through the user interface 10. Then, the controller 20 receives a command for instructing the start of building an AI model from a user who recognizes the home screen output in this way through the user interface 10. FIG. 3 is an example view of a home screen among output screens of the user interface 10 illustrated in FIG. 1. A user may input a command for instructing the start of building an AI model to the user interface 10 by clicking on a “one-click model training” section among several sections on the home screen of FIG. 3.

In step 22, the controller 20 generates screen content for selecting any one of multiple datasets, and outputs a dataset selection screen according to the generated screen content through the user interface 10. Subsequently, the controller 20 receives a selection on any one of multiple datasets from a user who recognizes the dataset selection screen output in this way through the user interface 10.

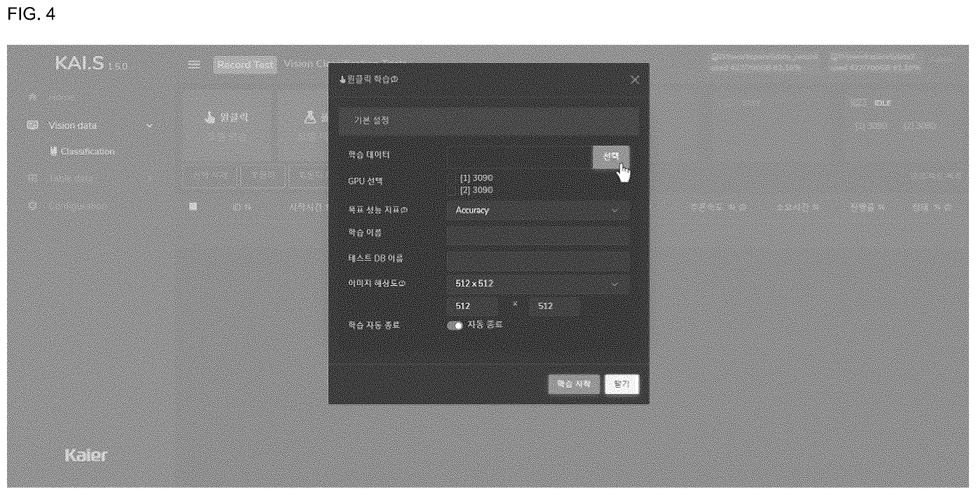

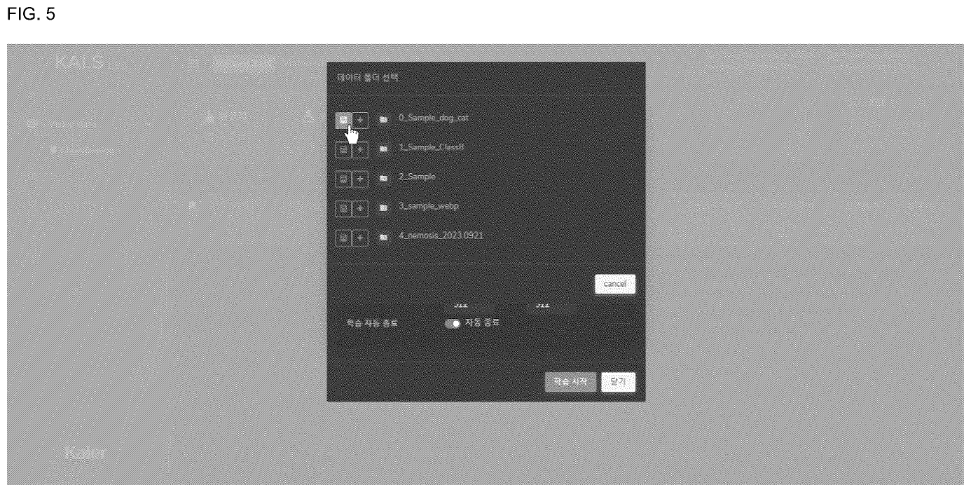

FIG. 4 and FIG. 5 are example views of dataset selection screens among output screens of the user interface 10 illustrated in FIG. 1. When a user clicks on an icon marked as “select” on the dataset selection screen of FIG. 4, the dataset selection screen of FIG. 5 is then output. The dataset selection screen of FIG. 5 displays multiple directories in which multiple datasets are stored. A user may select one of the multiple datasets by clicking on one of multiple directories displayed on the dataset selection screen of FIG. 5.

Each of the multiple directories stores each dataset and labels of each dataset. Each dataset consists of multiple pieces of unit data, and a label of each dataset consists of at least one label value. For example, each unit data may be data of an image having a size of 5×5. Here, the image having a size of 5×5 indicates an image having a horizontal length of 5 pixels and a vertical length of 5 pixels, that is, an image consisting of a total of 25 pixels.

The AI model automatic building device according to the present embodiment may be implemented by a computer, and the computer may include multiple graphic processing units (GPUs). A GPU to be used for training an AI model using a dataset selected by a user among multiple GPUs may be automatically selected by the controller 20 or may be manually selected by a user. AI model training may also be performed by using only a central processing unit (CPU) without using the GPU depending on features of the dataset.

In step 23, the data classification unit 30 classifies datasets selected by a user into a training dataset and a validation dataset. Some of the datasets are used for training, and some of datasets are used for validation. For example, the training unit 50 may randomly extract some of the datasets selected by a user and classify some of the datasets extracted in this way as training datasets. Subsequently, the training unit 50 classifies the other datasets excluding the training datasets as test datasets. The data classification unit 30 may also classify the datasets selected by a user into a training dataset, a validation dataset, and a test dataset. The test dataset may be used to measure the performance of an AI model built according to the present embodiment. The performance of the AI model refers to an indicator of how accurately and quickly the AI model may provide a prediction result for input data.

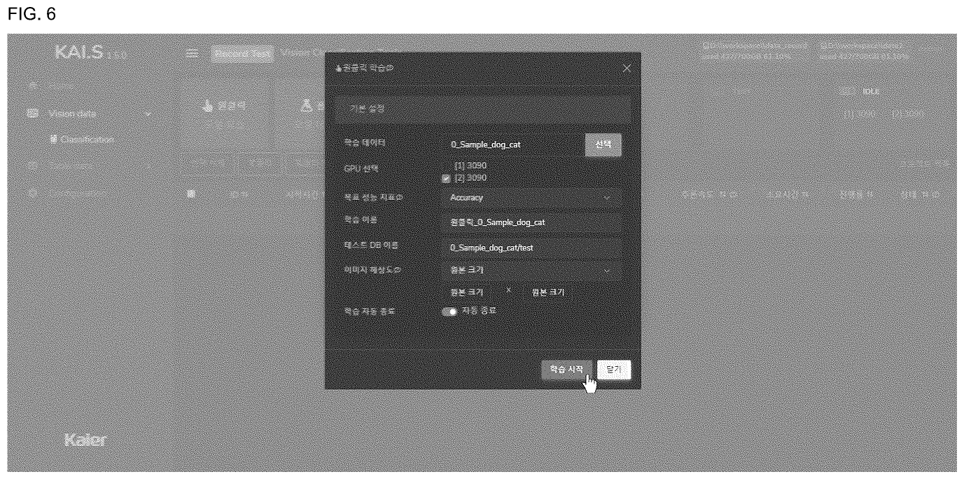

In step 24, the controller 20 receives a training start command of an AI model using the dataset selected by a user from the user through the user interface 10. When the training start command of an AI model is input from a user, the controller 20 initializes multiple hyperparameters and multiple modeling elements for building the AI model. The controller 20 may initialize the multiple hyperparameters and the multiple modeling elements by setting values of the multiple hyperparameters and the multiple modeling elements to preset initial values. FIG. 6 is an example view of a training start screen among output screens of the user interface 10 illustrated in FIG. 1. A user may input a training start command of an AI model by clicking on a “start training” icon on a user interface screen of FIG. 6.

For examples, a hyperparameter may include a learning rate, a batch size, an epoch number, and so on. The learning rate refers to the amount of update of each weight of an AI model when updating each weight such that loss calculated from a difference between an output of the AI model and a label corresponding to the output is minimized. The less the learning rate, the more finely each weight is changed. The batch size refers to a division size of a training dataset for smooth training of the AI model, and the training dataset is divided into the number of mini-batches corresponding to the batch size. For example, in a case where the training dataset includes 1000 pieces of unit data, when the batch size is 10, the 1000 pieces of unit data are divided into 10 mini-batches. In this case, each mini-batch includes 100 pieces of unit data.

The epoch number refers to training repetition number of times of the AI model for the entire training dataset. In each epoch, AI model training is performed once for the entire training data. For example, when the epoch number is 50, the AI model training for the entire training dataset is performed 50 times. In summary of the examples described above, when the AI model training is performed for 100 pieces of unit data of one mini-batch, the training for that mini-batch is completed. When the AI model training for the other 9 mini-batches is completed, training for one epoch is completed. When the AI model training for the other 49 epochs is completed through the same process, the AI model training according to the batch size and the epoch number set in step 24 is completed.

A representative example of multiple modeling elements for an AI model may include a neuron number of each layer of a multi-layer perceptron (MLP) model, a layer number of the MLP model, the number of convolutional layers and pooling layers in a convolutional neural network (CNN) model, a feature map size of each convolutional layer in the CNN model, the neuron number of each layer of a fully connected (FC) layer in the CNN model, the layer number of the FC layer, and so on. In addition to the modeling elements listed above, there may be other modeling elements for the AI model. A structure of the AI model is determined by the multiple modeling elements.

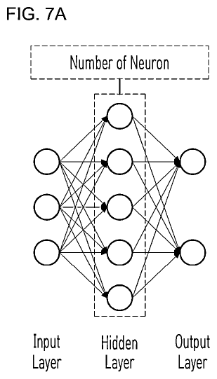

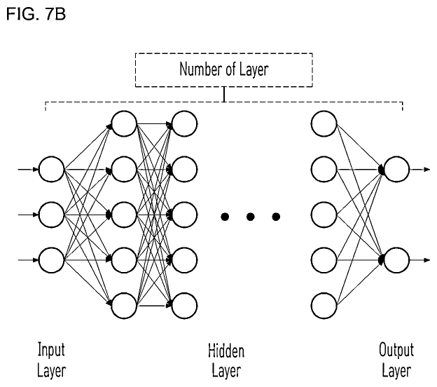

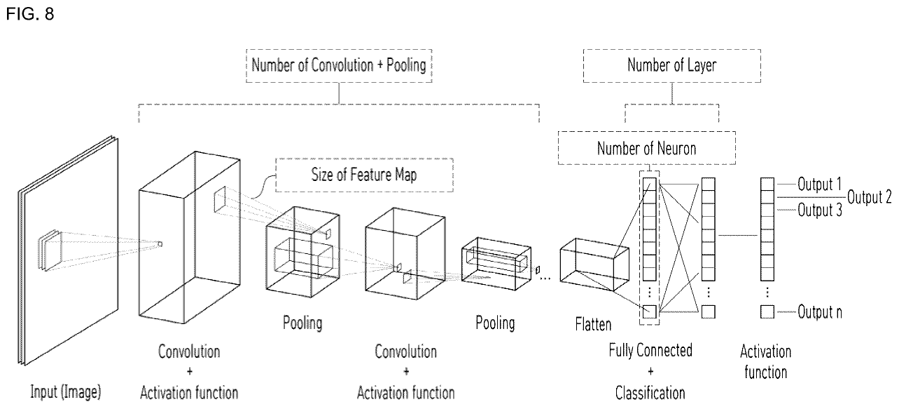

FIGS. 7A, 7B, and 8 are example diagrams of modeling elements of the modeling unit 40 illustrated in FIG. 1. FIG. 7A and FIG. 7B illustrates two modeling elements of an MLP model. Referring to FIG. 7A, the neuron number of each layer of the MLP model indicates how many neurons each layer, such as an output layer of the MLP model, at least one hidden layer, or an output layer, includes. Referring to FIG. 7B, the layer number of the MLP model indicates the total number of multiple layers, which constitute the MLP model, such as an output layer of the MLP model, at least one hidden layer, and an output layer.

FIG. 8 illustrates four modeling elements of a CNN model. Referring to FIG. 8, the number of convolutional and pooling layers of the CNN model indicates the total number of convolutional and pooling layers that are connected consecutively. A feature map size of each convolutional layer of the CNN model indicates a size of each feature map in each convolutional layer. The neuron number of each layer of an FC layer of the CNN model indicates how many neurons each layer of the FC layer includes. The layer number of the FC layer indicates how many layers the FC layer includes.

In step 25, the modeling unit 40 models an AI model according to the multiple modeling elements initialized in step 24 or adjusted in step 214. When the process proceeds from step 24 to step 25, the modeling unit 40 models the AI model according to the multiple modeling elements initialized in step 24. When the process proceeds from step 214 to step 25, the modeling unit 40 models the AI model according to the multiple modeling elements adjusted in step 214.

For example, when the layer number of the MLP model is set to 3, the neuron number of an input layer is set to 3, the neuron number of a hidden layer is set to 4, and the neuron number of an output layer is set to 2, the modeling unit 40 may model an AI model having a structure illustrated in FIG. 7A. The structure of the AI model most suitable for characteristics of a dataset changes depending on the characteristics of the datasets selected by a user. Therefore, in order to obtain an accurate prediction result of an AI model, the AI model having a structure suitable for the characteristics of the dataset selected by the user has to be modeled.

For example, in a case where each unit data of a dataset represents a text and a label of the dataset is a value representing the meaning of the text, when unit data is input, an MLP model is suitable for an AI model to predict the meaning of the unit data. In this case, the neuron number of an input layer changes depending on a size of the text, the neuron number of an output layer changes depending on the diversity of meaning, and the layer number and neuron number of the hidden layer change depending on difficulties of meaning prediction.

In a case where each unit data of a dataset represents an image and s label of the dataset is a value representing s shape of the image, when unit data is input, a CNN model is suitable for an AI model to predict a shape of the unit data. As in the example of the MLP model, values of the modeling elements change depending on sizes of an image input to the AI model, the variety of shapes predicted by an AI model, and the difficulty of shape prediction.

In step 26, the training unit 50 prepares a mini-batch to be used for the current epoch from the training dataset classified in step 23 according to the batch size initialized in step 24 or adjusted in step 214. The training dataset is divided into multiple mini-batches according to the batch size among the multiple hyperparameters initialized in step 24 or adjusted in step 214. For example, when the training dataset includes 1000 pieces of unit data and the batch size is 10, the training unit 50 may prepare a mini-batch including 100 pieces of unit data by extracting the 100 pieces of unit data from the other datasets excluding the datasets used for the previous training cycle among the 1000 pieces of unit data.

When the process is performed in the order of step 24, step 25, and step 26, the training unit 50 prepares a mini-batch to be used for the current epoch from the training dataset classified in step 26 according to the batch size initialized in step 24. When the process is performed in the order of step 214, step 25, and step 26, the training unit 50 prepares a mini-batch to be used for the current epoch from the training datasets classified in step 26 according to the batch size adjusted in step 214. In the present embodiment, the AI model training is performed by repeating step 26 to step 28. Here, the current epoch indicates one epoch, in which the AI model training is currently being performed, among the multiple epochs initialized in step 24 or according to the epoch number adjusted in step 214.

According to the present embodiment, an AI model is re-modeled whenever the multiple hyperparameters and multiple modeling elements are adjusted in step 214, and new training for an AI model based on the adjusted multiple hyperparameters starts again. In the present embodiment, a training section of an AI model based on the multiple hyperparameters and multiple modeling elements becomes one training cycle before the adjustment in step 214, and a new training cycle starts whenever adjustment is made in step 214. When the training cycle is repeated, the entire training process of an AI model becomes multiple training cycles. The current training cycle becomes the last training cycle in which training of an artificial neural network is currently being performed among the multiple training cycles, that is, a training cycle corresponding to multiple epochs according to the epoch number last adjusted in step 214.

In step 27, the training unit 50 obtains an output of an AI model according to an input of each unit data by inputting each unit data of the current mini-batch, which is a mini-batch prepared in step 26, to the AI model modeled by the modeling unit 40 in step 25, and calculates a forward propagation loss of the current mini-batch from a difference between an output of the AI model for each unit data obtained in this way and a label of the dataset selected by a user. The output of the AI model may be composed of at least one predicted value for each unit data, and the label of the dataset selected by the user may be composed of at least one label value corresponding to at least one predicted value. The forward propagation loss of the current mini-batch may be calculated by using a loss function, such as mean squared error (MSE).

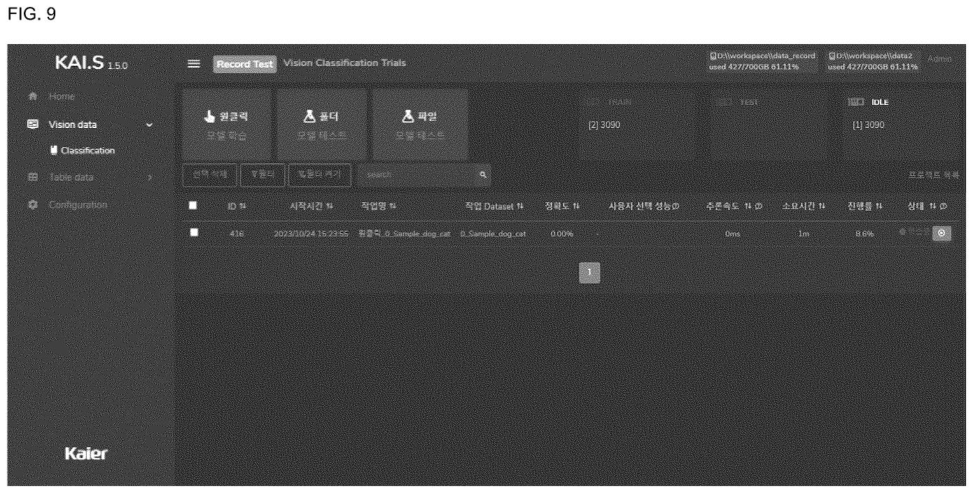

In step 28, the training unit 50 trains the AI model by backpropagating the forward propagation loss of the current mini-batch calculated in step 27 through the AI model. In more detail, the training unit 50 trains the AI model by updating each of multiple weights of the AI model from an output layer of the AI model toward an input layer such that the forward propagation loss of the current mini-batch calculated in step 27 is reduced. In this way, in step 26, step 27, and step 28, the training unit 50 trains the AI model modeled in step 25 according to the multiple hyperparameters initialized in step 24 or adjusted in step 214 using any one of the datasets selected by a user. FIG. 9 is an example view of a training progress screen among output screens of the user interface 10 illustrated in FIG. 1.

In step 29, the controller 20 checks whether the AI model training for all the multiple mini-batches according to the batch size initialized in step 24 or adjusted in step 214 is completed in the current epoch, which is one of the multiple epochs in which the AI model training is currently being performed according to the epoch number initialized in step 24 or adjusted in step 214. When a result of the check in step 29 shows that the AI model training in the current epoch is completed, the process proceeds to step 210. Otherwise, the process returns to step 26.

Until the AI model training in the current epoch is completed, step 26, step 27, and step 28 are repeated as many times as the batch size initialized in step 24 or adjusted in step 214. For example, when the batch size is 10, step 26, step 27, and step 28 are repeated 10 times until the AI model training in the current epoch is completed. In step 26, step 27, and step 28, the training unit 50 calculates a forward propagation loss of each mini-batch from a difference between an output of the AI model for each of the multiple mini-matches divided from the training dataset according to the batch size initialized in step 24 or adjusted in step 214 and a label of one of the datasets selected by a user, and trains the AI model by backpropagating the forward propagation loss of each mini-batch calculated in this way through the AI model.

In step 210, the calculation unit 60 calculates a training loss and training accuracy of the current epoch. The calculation unit 60 may calculate a training loss of the current epoch by calculating an average of the forward propagation losses calculated for all the multiple mini-batches according to repetition of step 27 as much as the batch size initialized in step 24 or adjusted in step 214. The calculation unit 60 may calculate training accuracy of the current epoch from the number of outputs that match the label of one of the datasets selected by a user among multiple outputs of the AI model obtained for all the multiple mini-batches by repeating step 27.

For example, when 10 forward propagation losses were calculated from 10 mini-batches in the current epoch, the calculation unit 60 may calculate a training loss of the current epoch by calculating an average of the 10 forward propagation losses. When the total number of multiple outputs of an AI model according to repetition of training for each mini-batch in the current epoch is 20 and the number of outputs that match a label of a dataset among the multiple outputs of the AI model is 10, the training accuracy is 50%.

In step 211, the calculation unit 60 calculates a valid loss and valid accuracy of the current epoch. The calculation unit 60 obtains an output of the AI model according to the input of each unit data by inputting each unit data of a validation dataset classified in step 23 to an artificial neural network trained in step 26, step 27, and step 28, and calculates a valid loss of the current epoch from differences between the multiple outputs of an AI model for all pieces of the validation datasets obtained in this way and labels of the datasets selected by a user. The calculation unit 60 may calculate valid accuracy of the current epoch from the number of outputs that match a label of any one of the datasets selected by a user among the multiple outputs of an AI model obtained for all the validation datasets.

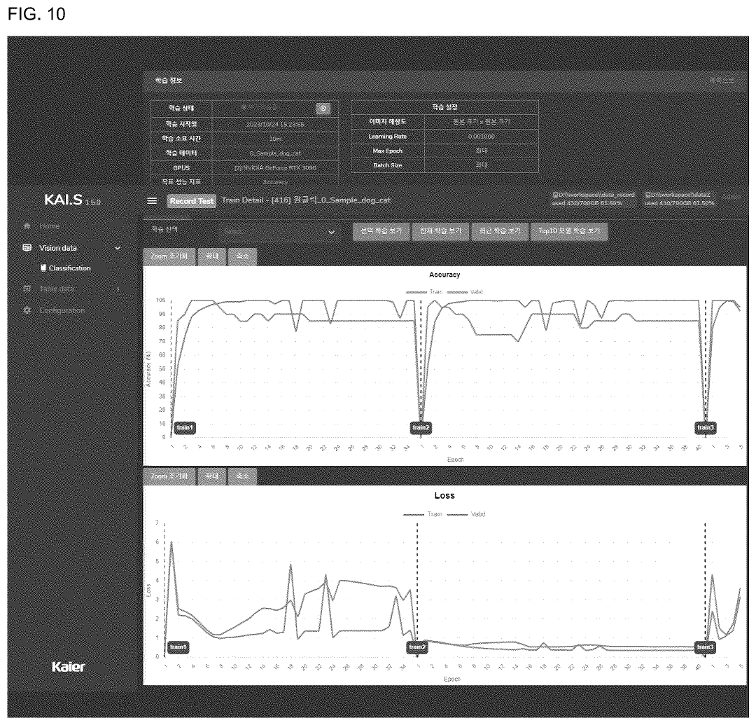

FIG. 10 is an example view of a loss and accuracy display screen among output screens of the user interface 10 illustrated in FIG. 1. Referring to FIG. 10, training loss and training accuracy, and valid loss and valid accuracy according to a training process of the AI model according to the present embodiment are displayed in the form of graphs. An upper graph shows training accuracy and valid accuracy, and a lower graph shows a training loss and a valid loss. An x-axis of each graph represents epoch accumulation according to training accumulation of an AI model, and a y-axis of each graph represents a loss and accuracy. In FIG. 10, “train1” corresponds to a first training cycle, “train2” corresponds to a second training cycle, and “train3” corresponds to a third training cycle.

In step 212, the controller 20 determines whether the performance of an AI model in the current training cycle is converged or whether training of the AI model for all epochs in the current training cycle is completed based on a training loss and training accuracy of the current epoch calculated by the calculation unit 60 in step 210 and training losses and training accuracies of multiple epochs prior to the current epoch calculated by the calculation unit 60. When the decision result in step 212 indicates that the performance of the AI model in the current training cycle is converged or that the training of the AI model for all epochs in the current training cycle is completed, the process proceeds to step 213. Otherwise, the process returns to step 26. That is, when the performance of the AI model in the current training cycle is before convergence and there are epochs in which training is not yet performed in the current training cycle, the process returns to step 26.

The training loss and training accuracy of the multiple epochs prior to the current epoch calculated by the calculation unit 60 indicates the training loss and training accuracy of the multiple epochs calculated in step 26 to step 210 that are repeatedly performed prior to step 26 to step 210 which are currently performed. All epochs of the current training cycle indicates all of the multiple epochs according to the epoch number in the current cycle.

The controller 20 determines whether the performance of the AI model in the current training cycle is converged based on change patterns of the training loss of the current epoch and the training losses of the multiple epochs prior to the current epoch and change patterns of the training accuracy of the current epoch and the training accuracies of the multiple epochs prior to the current epoch. For example, in a case where the epoch number is 50, when AI model training is performed in 40 epochs from among the 50 epochs, the controller 20 may determine that the performance of the AI model in the current training cycle is converged when there is no increase in the training loss calculated from the last 5 epochs in which training is finally performed and there is no decrease in the training accuracy.

In step 213, the controller 20 determines whether the performance of the AI model in the entire training process consisting of the current training cycle and multiple training cycles prior to the current training cycle is converged or whether the AI model training for all epochs in the entire training process is completed. As a result of the decision at step 213, when the performance of the AI model in the entire training process is converged or the AI model training for all epochs in the entire training process is completed, the process proceeds to step 215. Otherwise, the process proceeds to step 214. That is, when the performance of the AI model in the entire training process is not yet converged and there are epochs, in which training is not yet performed, in the entire training process, the process proceeds to step 214.

The controller 20 determines whether the performance of the AI model is converged in the entire training process based on a change pattern of the training loss and a change pattern of the training accuracy in the current training cycle and a change pattern of the training loss and a change pattern of the training accuracy in each of multiple training cycles prior to the current training cycle. All epochs of the entire training process mean all epochs of the multiple training cycles that constitute the entire training process.

For example, when a training loss reduction slope indicated by a change pattern of a training loss in the current training cycle is less than a training loss reduction slope indicated by a change pattern of a training loss in a training cycle prior to the current training cycle, and when a training accuracy increase slope indicated by a change pattern of training accuracy in the current training cycle is less than a training accuracy increase slope indicated by a change pattern of training accuracy in a training cycle prior to the current training cycle, the controller 20 may determine that the performance of the AI model in the entire training process is converged.

As described above, the training loss and training accuracy in the present embodiment are calculated based on an output of an artificial neural network trained in step 26, step 27, and step 28, and accordingly, the controller 20 may determine, in step 212 and step 213, whether the performance of an AI model is converged based on the output of the AI model trained in step 26, step 27, and step 28. That is, the controller 20 may determine whether the performance of an AI model is converged based on a difference between the output of the artificial neural network trained in step 26, step 27, and step 28 and a label of one dataset among the datasets selected by a user.

In step 214, the controller 20 adjusts multiple hyperparameters and multiple modeling elements such that the training loss calculated from the preset number of multiple training cycles decreases and the training accuracy calculated therefrom increases, based on the change pattern of the training loss and the change pattern of the training accuracy, which are calculated from the preset number of multiple training cycles during the entire training process. As described above, when the performance of an AI model in the current training cycle is converged before the performance of the AI model in the entire training process is converged, the controller 20 adjusts multiple hyperparameters and multiple modeling elements.

An AI model is re-modeled according to the multiple modeling elements adjusted in this way, and the AI model is re-trained according to the multiple hyperparameters adjusted in this way. Adjustments of the multiple hyperparameters and multiple modeling elements and the training of an AI model are performed repeatedly until performance of the AI model is converged. For example, when the preset number is 3, the controller 20 may adjust the multiple hyperparameters and multiple modeling elements such that the training loss calculated from the current training cycle and the previous two training cycles decreases and the training accuracy calculated therefrom increases, based on the change patterns of the training loss and the training accuracy calculated from the current training cycle, which is the last training cycle, and the previous two training cycles.

The controller 20 adjusts the multiple hyperparameters and the multiple modeling elements by changing a value of at least one of the multiple hyperparameters and the multiple modeling elements such that the training loss calculated from the preset number multiple training cycles decreases and the training accuracy calculated therefrom increases. For example, the controller 20 may change a batch size or an epoch number such that the training loss calculated from the preset number of multiple training cycles decreases and the training accuracy calculated therefrom increases, or may change a neuron number in each layer of an AI model or change a layer number of the AI model such that the training loss calculated from the preset number of multiple training cycles decreases and the training accuracy calculated therefrom increases.

In step 215, the controller 20 selects an AI model trained in one training cycle among the AI models trained in each of multiple training cycles constituting the entire training process as the final authentication intelligence model based on multiple valid losses and multiple valid accuracies calculated from the multiple training cycles constituting the entire training process. According to the above description, one valid loss and one valid accuracy are calculated for each training cycle. Here, the multiple training cycles constituting the entire training process indicates the current training cycle in which the AI model training is last performed and all training cycles prior to the current training cycle.

For example, the controller 20 determines a training cycle having three relatively small calculation unit losses among multiple calculation unit losses calculated from the multiple training cycles constituting the entire training process, determines a training cycle having the greatest training accuracy among three valid losses, and selects the AI model trained in the training cycle determined in this way as the final authentication intelligence model.

According to the present embodiment, a process of adjusting multiple hyperparameters and a process of training an AI model according to the multiple hyperparameters using one dataset selected by a user are repeated until the performance of the AI model is converged, and thus, the multiple hyperparameters may be automatically adjusted to be optimized for the dataset selected by the user. A process of adjusting multiple modeling elements and a process of training an AI model modeled according to the multiple modeling elements using one dataset selected by a user are repeated until the performance of the AI model is converged, and thus, a structure of the AI model may be automatically adjusted to be optimized for the dataset selected by the user.

In this way, as a user simply selects any one of multiple datasets, training of an AI model having a structure optimized for the dataset selected by a user is performed according to the hyperparameter optimized for the dataset selected by the user, and thus, an AI model, which may provide a prediction result having very high accuracy with an optimal and efficient structure for the dataset selected by the user, may be automatically built.

A process of adjusting multiple hyperparameters and a process of training an AI model modeled according to the multiple hyperparameters using one dataset selected by a user are repeated until the performance of the AI model is converged, and thus, the multiple hyperparameters may be automatically adjusted to be optimized for the dataset selected by the user. A process of adjusting multiple modeling elements and a process of training an AI model modeled according to the multiple modeling elements using one dataset selected by a user are repeated until performance of the AI model is converged, and thus, a structure of the AI model may be automatically adjusted to be optimized for the dataset selected by the user.

As described above, as a user simply selects one of multiple datasets, an AI model having a structure optimized for the dataset selected by the user is trained according to the hyperparameter optimized for the dataset selected by the user, and thus, an AI model that may provide a prediction result having very high accuracy with an optimal and efficient structure for the dataset selected by the user may be automatically built. Embodiments are not limited to the effects described above, and other effects may be derived from the following descriptions.

In addition, the AI model automatic building method according to one embodiment of the present disclosure described above may be implemented as a program executable by a computer processor, and may be performed by a computer that records and executes the program on a computer-readable recording medium. The computer includes all types of computers that may execute programs, such as a desktop computer, a laptop computer, a smartphone, and an embedded-type computer. In addition, the structure of data used in one embodiment of the present disclosure described above may be recorded on a computer-readable recording medium through various means. Computer-readable recording media include storage media, such as RAM, ROM, an SSD, magnetic storage media (for example, floppy disks, hard disks, and so on), and optical readable media (for example, compact disk (CD)-ROMs, digital video disks (DVDs), and so on).

The present disclosure is described above with reference to preferred embodiments thereof. Those skilled in the art to which the present disclosure belongs will appreciate that the present disclosure may be implemented in modified forms without departing from the essential characteristics of the present disclosure. Therefore, the disclosed embodiments should be considered from an illustrative rather than a limiting perspective. The scope of the present disclosure is set forth in the claims, not in the foregoing description, and all differences within the scope equivalent thereto should be construed as being included in the present disclosure.

What is claimed is:

1. An artificial intelligence model automatic building method comprising:
receiving a dataset selected by a user among multiple datasets;
training an artificial intelligence model according to multiple hyperparameters using the dataset selected by the user;
determining whether performance of the artificial intelligence model is converged based on an output of a trained artificial intelligence model; and
adjusting the multiple hyperparameters according to whether the performance of the artificial intelligence model is converged, and
wherein the artificial intelligence model is trained again according to the adjusted multiple hyperparameters, and the adjustment of the multiple hyperparameters and the training of the artificial intelligence model are repeated until the performance of the artificial intelligence model is converged.

2. The artificial intelligence model automatic building method of claim 1, wherein,
in the determining of whether the performance of the artificial intelligence model is converged, whether the performance of the artificial intelligence model is converged is determined based on a difference between an output of the trained artificial intelligence model and a label of the dataset.

3. The artificial intelligence model automatic building method of claim 1, wherein
the multiple parameters include a batch size which is a division size of a training dataset of the dataset selected by the user, and
the training of the artificial intelligence model includes:
calculating a forward propagation loss of each mini-batch from a difference between an output of the artificial intelligence model for each of multiple mini-matches divided from the training dataset according to the batch size and a label of the dataset selected by the user; and
training the artificial intelligence model by backpropagating the calculated forward propagation loss of the each mini-batch through the artificial intelligence model.

4. The artificial intelligence model automatic building method of claim 3, wherein
the multiple hyperparameters further include an epoch number which is a number of repetitions of training of the artificial intelligence model,
the artificial intelligence model automatic building method further includes calculating a training loss of a current epoch from multiple forward propagation losses calculated for all of multiple mini-batches, when the training of the artificial intelligence model for all of the multiple mini-batches is completed in the current epoch, which is one epoch in which the training of the artificial intelligence model is currently being performed among multiple epochs according to the epoch number, and
in the determining of whether the performance of the artificial intelligence model is converged, whether the performance of the artificial intelligence model is converged in a current training cycle which is a training cycle corresponding to the multiple epochs according to the epoch number, is determined based on the calculated training loss of the current epoch and a training loss of the multiple epochs prior to the current epoch.

5. The artificial intelligence model automatic building method of claim 4, wherein
in the calculating of the training loss of the current epoch, training accuracy of the current epoch is calculated from a number of outputs that match a label of the one dataset among multiple outputs of the artificial intelligence mode for all of the multiple mini-batches, together with a training loss of the current epoch and,
in the determining of whether the performance of the artificial intelligence model is converged, whether the performance of the artificial intelligence model is converged in the current training cycle is determined based on the calculated training loss and training accuracy of the current epoch and training losses and accuracies of the multiple epochs prior to the current epoch.

6. The artificial intelligence model automatic building method of claim 4, further comprising:
determining whether the performance of the artificial intelligence model in an entire training process consisting of the current training cycle and multiple training cycles prior to the current training cycle is converged, when the performance of the artificial intelligence model in the current training cycle is converged,
wherein, in the adjusting of the multiple hyperparameters, the multiple hyperparameters are adjusted when the performance of the artificial intelligence model in the current training cycle is converged before the performance of the artificial intelligence model in the entire training process is converged.

7. The artificial intelligence model automatic building method of claim 6, wherein,
in the adjusting of the multiple hyperparameters, the multiple hyperparameters are adjusted such that training loss calculated from a preset number of the multiple training cycles decreases based on a change pattern of the training loss calculated from the preset number of the multiple training cycles in the entire training process.

8. The artificial intelligence model automatic building method of claim 7, further comprising:
calculating valid loss of the current epoch from a difference between multiple outputs of an artificial intelligence model obtained by inputting a validation dataset among the one dataset to the trained artificial intelligence model and a label of the one dataset; and
selecting an artificial intelligence model trained in one training cycle among artificial intelligence models trained in each of multiple training cycles constituting the entire training process based on multiple valid losses calculated from multiple training cycles constituting the entire training process when the performance of the artificial intelligence model in the entire training process is converged.

9. The artificial intelligence model automatic building method of claim 6, wherein,
in the calculating of valid loss of the current epoch, valid accuracy of the current epoch is calculated from outputs that match a label of the dataset among multiple outputs of the artificial intelligence model obtained by inputting the valid dataset to the trained artificial intelligence model, together with valid loss of the current epoch, and
in the selecting of the artificial intelligence model, an artificial intelligence model trained in one training cycle is selected from among artificial intelligence models trained in each of multiple training cycles constituting the entire training process, based on multiple valid losses and multiple valid accuracies calculated in the multiple training cycles constituting the entire training process.

10. The artificial intelligence model automatic building method of claim 1, further comprising:
modeling the artificial intelligence model according to multiple modeling elements,
wherein, in the adjusting of the multiple hyperparameters, the multiple hyperparameters and the multiple modeling elements are adjusted, and
the artificial intelligence model is re-modeled according to the adjusted multiple modeling elements, and adjustment of the multiple hyperparameters and the multiple modeling elements and the training of the artificial intelligence model are repeated until the performance of the artificial intelligence model is converged.

11. The artificial intelligence model automatic building method of claim 10, wherein
the multiple modeling elements include at least one of a neuron number of respective layers of the artificial intelligence model and a layer number of the artificial intelligence model.

12. A computer-readable recording medium in which a program for performing the artificial intelligence model automatic building method of claim 2 by a computer is recorded.

13. An automatic artificial intelligence model building device comprising:
a user interface configured to receive a dataset selected by a user among multiple datasets;
a training unit configured to train an artificial intelligence model according to multiple hyperparameters using the dataset selected by the user; and
a controller configured to determine whether performance of the artificial intelligence model is converged based on an output of a trained artificial intelligence model, and adjust the multiple hyperparameters according to whether the performance of the artificial intelligence model is converged,
wherein the artificial intelligence model is trained again according to the adjusted multiple hyperparameters, and the adjustment of the multiple hyperparameters and the training of the artificial intelligence model are repeated until the performance of the artificial intelligence model is converged.
